(19) United States
(12) Patent Application Publication
(10) Pub. No.: US 2008/0055626 A1
(43) Pub. Date: Mar. 6, 2008

(54) USE OF MARKING SETS TO RECOVER FROM AN INTERRUPTED PRINT JOB

(76) Inventors: James L. Root, Rochester, NY (US); Edward N. Chapman, Rochester, NY (US); Edward M. Housel, Rochester, NY (US)

Correspondence Address: David A. Novais;Eastman Kodak Company, Patent Legal Staff, 343 State Street, Rochester, NY, 14650-2201, US

(21) Appl. No.: 11/468,429

(22) Filed: Aug. 30, 2006

(51) Int. Cl. G06K 15/00

(52) U.S. Cl. 358/1.14

(57) ABSTRACT

In a system and method for facilitating recovery from an interrupted print job, marking sets are inserted into the print job to determine where such interruption occurred. The marking sets identify a location within the print job, and by providing such marking sets to a reading device, a print job control system communicatively connected thereto is able to determine which portion or portions of the print job failed to complete. Thereafter, the print job control system initiates reprinting of the portion or portions of the print job that were interrupted.

### FIELD OF THE INVENTION

This invention relates to facilitating recovery from an interrupted variable data print job. In particular, the present invention pertains to using marking sets inserted into a variable data print job that may be used to identify a portion of the variable data print job that needs to be reprinted due to the interruption.

### BACKGROUND OF THE INVENTION

FIG. 1 illustrates a conventional printing system 100. According to the system 100, a print job 102 is submitted to a printer-front-end 104, which essentially is a user interface having processing circuitry associated therewith. According to conventional non-variable data printing, the print job 102 typically represents a plurality of documents, of which multiple copies are printed. Stated differently, for example, a document may consist of two pages where an operator may desire to print three sets of that document. Such a simplified example is illustrated in FIG. 1 with “set 1” 106, “set 2” 108, and “set 3” 110. “Set 1” 106 represents a first copy of the two page document, “set 2” 108 represents a second copy of the two page document, and “set 3” 110 represents a third copy of the two page document.

Upon receipt of the print job 102 at the printer-front-end 104, the print job 102 is rasterized by a raster image processor (RIP), which converts the print job 102 into a format native to the printer 112. After rasterizing the print job 102, the printer-front-end 104 submits the rasterized-print-job to the printer 112 for printing. After printing, one or more finishing tasks may need to be performed on the printed job, such as stapling, trimming, binding, or glossing, by one or more finishing devices 114. Conventionally, two types of finishing devices exist: in-line finishing components 116 and off-line finishing components 120.

In-line finishing components 116, as defined herein, are finishing components capable of providing status information 118 in a feedback loop to the printer-front-end 104. The status information 118 indicates, among other things, to the printer-front-end 104 whether the in-line finishing component has successfully completed its finishing operations. For example, if, during the process of finishing “set 2” 108, an in-line component fails to properly finish page 2 of such set, as illustrated with reference numeral 124, the in-line finishing component may transmit status information 118 to the printer-front-end 104 indicating such failure. Accordingly, the printer-front-end 104 initiates a reprint of the print job 102 beginning at the second page of “set 2” 108. This iterative process repeats until all of the in-line finishing components 116 indicate to the printer-front-end 104 via status information 118 that the print job 102 has been successfully finished by such components 116.

Off-line finishing components 120, as defined herein, refer to finishing components that do not provide status information, such as status information 118, to the printer-front-end 104. Consequently, the printer-front-end 104 does not know whether or not a printed print job has been successfully finished by the off line finishing components 120. Therefore, according to conventional schemes, if an error occurred at the second page of “set 2” 108 while performing off line finishing, an operator would have to manually review the entire set of successfully finished pages and manually determine where the error occurred. In the simplistic example given in FIG. 1, an operator would need to flip through a few pages to determine that an error occurred at the second page of “set 2” 108, and then have to manually initiate reprinting of the print job beginning at the second page of set 2.

However, further complications arise when print jobs contain many copies of long documents not having page numbers, thereby requiring a significant investment of time of an operator to review which pages of the print job were successfully finished and which pages were not successfully finished.

In addition, when print jobs contain variable data, and each document set contains different numbers of pages, the operator's task of determining which pages need to be reprinted becomes even more complex. For example, the conventional print system 200 illustrated in FIG. 2 includes the same physical components as those in FIG. 1, except that those physical components are configured to perform variable data printing. In the case of variable data printing, a print job 202 also includes a plurality of document sets to be printed, referred to as “set 1” 206, “set 2” 208, and “set 3” 210. In contrast to static printing illustrated in FIG. 1, the documents in FIG. 2 contain different content and different numbers of pages. For example, “set 1” 206 includes three pages: page one, page two, and page three. “Set 2” 208 includes only a single page, but that page corresponds to page two of “set 1” 206. In “set 2” 208, pages one and three of “set 1” 206 are absent. Further, “set 3” 210 includes a document having two pages corresponding to page one and page three, respectively, of “set 1” 206. However, a page corresponding to page two of “set 1” 206 is absent from “set 3” 210.

A practical, but simple example of a print job such as that illustrated in FIG. 2 is custom advertisements targeted towards particular customers. Depending upon a customer's interests, that customer may receive particular advertisements. For example, if a customer has declared that she is interested in golf, horseback riding, and tennis, she may receive three coupons, one for golf equipment, one for equine equipment, and one for tennis equipment. However, a second customer may have declared that he is interested in golf. Accordingly, he will only receive the coupon pertaining to golf equipment.

Returning to FIG. 2, the variable data print job 202 is submitted to the printer-front-end 204, which rasterizes the print job 202 and submits it to the printer 212 for printing. Finishing procedures then are performed by finishing devices 214, which, as before, include in-line finishing components 216 and off-line finishing components 220. The in-line finishing components 216 include the status feedback loop 218 to the printer-front-end 204 that the off-line finishing components 220 do not have. As with static-data printing illustrated in FIG. 1, the printer-front-end 204 is informed of finishing errors in the in-line finishing components 216 via the feedback loop 218 and automatically initiates reprinting of the failed pages. Also as with static-data printing, however, when an off-line finishing component fails to finish pages in the print job 202, the printer-front-end 204 does not know when errors occur in the off-line finishing components 220. Accordingly, the operator has to figure out which pages of the variable data print job 202 failed to be finished by such off-line finishing components 220, and must manually initiate reprinting of such pages. However, as compared to static printing, this situation is more complex, because determining which pages need to be reprinted is not as intuitive. For example, assume that all pages after page three of “set 1” 206 failed to be finished by an off-line finishing component, as illustrated with reference numeral 224. The operator may not know just by looking at the completed pages that “set 1” 206 has properly been finished and that “set 2” 208, which needs to be reprinted, includes only a single page corresponding to page two of “set 1” 206. Therefore, the amount of time spent by an operator determining which pages failed to be finished by off-line finishing components 220, and which pages need to be reprinted as a result, is substantially increased.

Accordingly, a need in the art exists for a way of easily figuring out where to initiate reprinting of a job that has failed in one or more off-line finishing components.

### SUMMARY OF THE INVENTION

The above described problem is addressed and a technical solution is achieved in the art by systems and methods for facilitating recovery of an interrupted print job according to the present invention. According to an embodiment of the present invention a plurality of marking sets are incorporated into a print job, each marking set identifying its location in the print job. The marking sets each may include a single marking or a plurality of markings, depending upon design choice. When the print job is interrupted during printing by one or more off-line finishing components, one or more of the marking sets may be used to indicate a portion or portions of the print job that need(s) to be reprinted due to the interruption. The print job may be a variable data print job or a static data print job, or both a static and a variable data print job. The marking sets may include bar codes, watermarks, text, numbers, or combinations thereof.

Further, each marking set may be located on a separate sheet in the print job, separate from the print job content. Such an arrangement ensures that the marking sets do not interfere with the print job content. In this case, the locations in the print job of the separate sheets containing the marking sets are user-definable. In addition, the number of separate sheets inserted into the print job also may be user-definable. Alternatively, each marking set may be on or imbedded into existing pages of the print job, such that additional pages of the print job are not added for the sake of the marking sets. The locations of the marking sets in this instance, also may be user-definable.

According to another embodiment of the present invention, a reading device is provided that is configured to read one or more of the marking sets. The reading device is communicatively connected to a print job controller that controls printing of the print job. The reading device provides data to the print job controller upon reading of one or more of the marking sets. With such data, the print job controller is able to determine which portion or portions of the print job is/are to be reprinted due to the interruption.

In addition to the embodiments described above, further embodiments will become apparent by reference to the drawings and by study of the following detailed description.

### BRIEF DESCRIPTION OF THE DRAWINGS

The present invention will be more readily understood from the detailed description of exemplary embodiments present below considered in conjunction with the attached drawings, of which:

FIG. 1 illustrates a conventional static printing system;

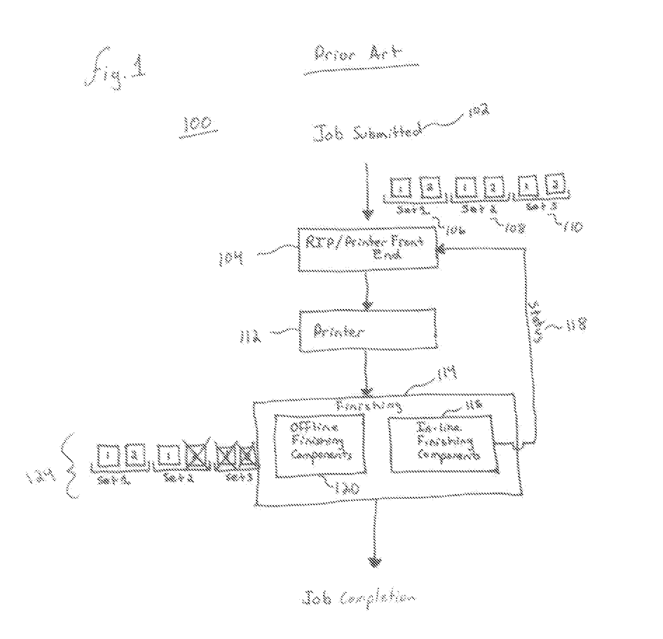

FIG. 2 illustrates a conventional variable data printing system;

FIG. 3 illustrates a system for facilitating recovery from an interrupted print job, according to an embodiment of the present invention;

FIG. 4 illustrates various marking techniques, according to embodiments of the present invention; and

FIG. 5 illustrates the facilitating of recovery from a print job having nonadjacent sheets that failed to print, according to an embodiment of the present invention.

It is to be understood that the attached drawings are for purposes of illustrating the concepts of the invention and may not be to scale.

### DETAILED DESCRIPTION OF THE INVENTION

The present invention assists an operator with recovering from an interrupted print job. The phrase “interrupted print job” as used herein, is intended to refer to any print job having pages that failed to properly print, whether or not the print job actually had to stop due to the failure. According to various embodiments of the present invention, failure recovery is achieved by the insertion of marking sets, which may have a user-definable format, into the print job at various locations, which also may be user-definable. The marking sets are configured to identify a location in the print job. When a print job is interrupted (i.e., has pages that fail to properly print), an operator may take the page of the print job that contains a marking set and provide it to a reading device. The reading device is able to read such marking set and inform the print job control system, such that the print job control system is able to determine which portion or portions of the print job need to be reprinted in order to recover from the interruption. Accordingly, an operator need not manually sort through an interrupted print job and manually determine which portion or portions of the print job need to be reprinted. According to the present invention, the operator need only retrieve a page of the print job that successfully printed at or near the point of print job failure, and provide the marking set on that page to the reading device to inform the print job control system of which portion or portions of the print job need to be reprinted.

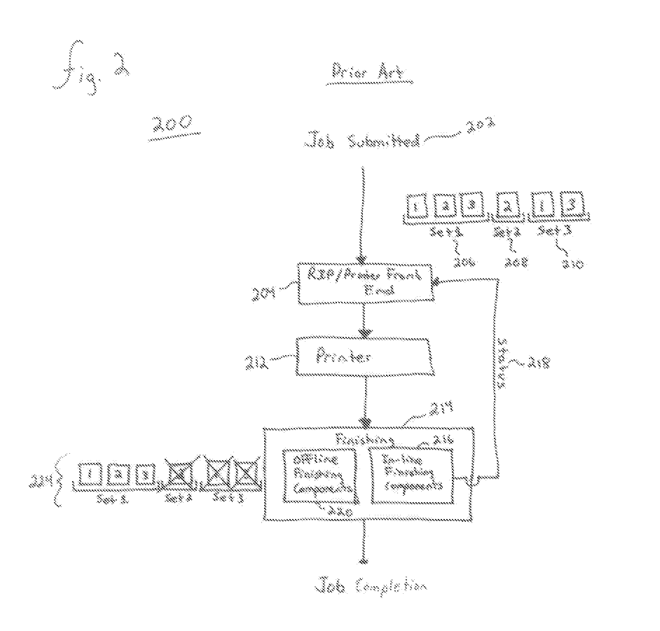

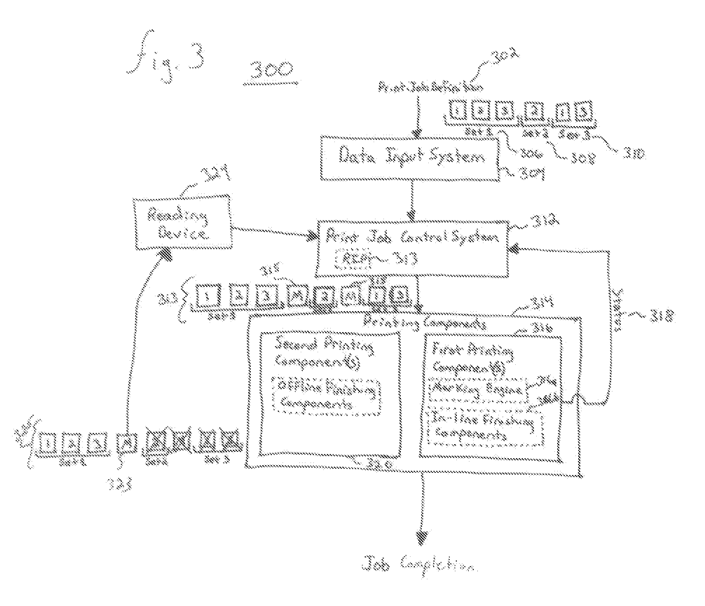

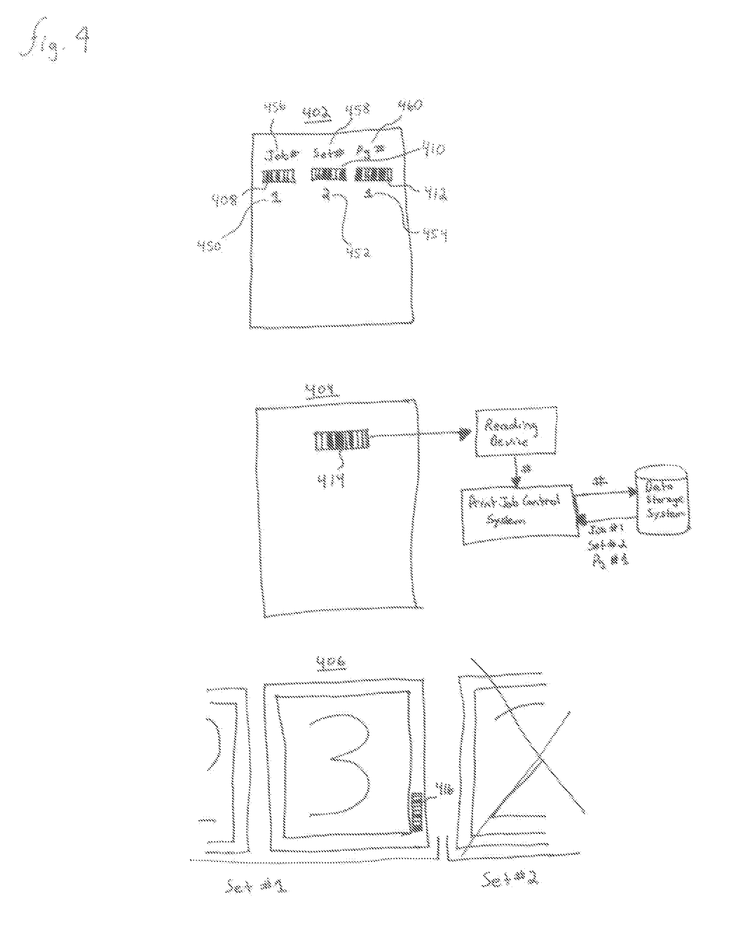

To elaborate, FIG. 3 will be described, which illustrates a system 300 for facilitating recovery from an interrupted print job, according to an embodiment of the present invention. According to this embodiment, a print job definition 302 is input into a data input system 304. The print job definition 302 includes information needed to describe a print job for printing, as well as any user-defined parameters associated with the insertion of marking sets into the print job as described in more detail below and with reference to FIG. 4. In the example of FIG. 3, the print job definition 302 defines a print job having three document sets: “set 1” 306, “set 2” 308, and “set 3” 310, corresponding respectively to the job structure illustrated in FIG. 2 with “set 1” 206, “set 2” 208, and “set 3” 210.

The print job definition 302 may be provided to the data input system 304 manually via a user interface or a printer-front-end included in the data input system 304. Alternatively, the print job definition 302 may be stored in a data storage system (not shown) and retrieved by the data input system 304. A data storage system may include one or more computer-accessible memories. On the other hand, such a data storage system need not be a distributed data-storage system and, consequently, may include one or more computer-accessible memories located within a single computer or device.

The phrase “computer-accessible memory” is intended to include any computer-accessible data storage device, whether volatile or non-volatile, electronic, magnetic, optical, or otherwise, including but not limited to, floppy discs, hard discs, compact discs, DVDs, flash memories, ROMs, and RAMs. Such a data storage system may be a distributed data-storage system including multiple computer-accessible memories communicatively connected via a plurality of computers and/or devices.

The phrase “communicatively connected” is intended to include any type of connection, whether wired, wireless, or both, between devices and/or computers and/or programs in which data may be communicated. The term “computer” is intended to include any data processing device, such as a desktop computer, a laptop, a mainframe computer, a personal digital assistant, a Blackberry®, and/or any other device for processing data, and/or managing data, and/or handling data, whether implemented with electrical and/or magnetic, and/or optical, and/or biological component, and/or otherwise.

Upon receipt of the print job definition 302, the data input system 304 transmits the print job definition 302, or a derivative thereof, to a print job control system 312. The print job control system is a computer that facilitates and manages printing of the print job. The print job control system 312 may include therein a raster image processor 313. The print job control system 312, based upon the information in the print job definition 302, inserts marking sets into the print job according to the parameters in the print job definition 302. In the example embodiment of FIG. 3, the marking sets are inserted into the print job on their own sheets 315. Further, in this example embodiment, the marking sheets are inserted in-between each document set, “set 1” 306, “set 2” 308, and “set 3” 310. In particular, a marking sheet 315 is inserted after completion of “set 1” and after completion of “set 2”. As will be described in more detail below with respect to FIG. 4, alternative arrangements for insertion of marking sets will be described. However, an advantage of having marking sets on their own sheets 315 is that the marking sets do not interfere with any of the print job content. In other words, the marking sets are not added to pages in the print job that have content on them.

The print job control system submits the modified print job 313, having the marking sets inserted therein, to one or more printing components 314 for printing. Example printing components 314 include first printing components 316 and second printing components 320. Examples of first printing components 316 include a printing engine 316a and an in-line finishing component 316b. The printing engine 316a refers to a printing component that forms an image with an image-forming material, such as ink or toner. In-line finishing components 316b correspond to finishing components, such as stapling devices, trimming devices, binding devices, or glossing devices, capable of providing status feedback 318 to the print job control system 312. To elaborate, the first printing components are capable of informing the print job control system 312 of when they have successfully printed or finished the portions of the print job assigned to them, or when they have failed to print or finish the portions of the print job assigned to them. When an error occurs during finishing by an in-line finishing component 316b, the print job control system 312 is notified and initiates reprinting of the improperly finished portions of the print job. In contrast, second printing components 320, which may include off-line finishing components known in the art, are not able to provide this type of status information to the print job control system 312.

According to the embodiment of FIG. 3, when an error occurs in one of the second printing components, the operator's job of reprinting the failed pages is greatly simplified as compared to conventional arrangements. In particular, assume that all pages in “set 2” 308 and “set 3” 310 fail to be finished by the second printing components 320, as shown with reference numeral 325. In this case, the operator provides the marking sheet 323, which is the most recently printed sheet having the marking or marking sets, to a reading device 324. The reading device reads the marking and provides data pertaining to the marking to the print job control system 312. With such data, the print job control system 312 determines which portion of the print job needs to be reprinted due to the error in the off-line finishing component 320. In this example, the marking(s) on sheet 323 specify that its location is immediately following “set 1” 306 or immediately preceding “set 2” 308. Consequently, the print job control system 312 determines that “set 2” 308 and everything thereafter needs to be reprinted. By referencing the print job definition, the print job control system knows exactly what contents belong to “set 2” 308 and “set 3” 310.

FIG. 4 illustrates marking sets according to various embodiments of the present invention. For example, illustration 402 shows that a set of markings 408, 410, 412, 450, 452, 454, 456, 458, 460 may be provided on a single sheet, such as sheet 323 shown in FIG. 3, to provide requisite information to the print job control system 312. In illustration 402, the set of markings includes a subset of bar code markings 408, 410, 412. In this case, the reading device 324 may be a bar code reader configured to read the bar codes 408, 410, 412. When the bar code reader reads the first bar code 408, it transmits the number associated with the first bar code 408 to the print job control system 312. Such control system 312 may be instructed (via a table or some other data or program source) that the number associated with the first bar code 408 identifies the job number in which the marking sheet is located. Upon scanning the second bar code 410, the print job control system 312 may be instructed that the number associated with this bar code identifies the set number before which (or after which, depending upon design choice) the marking sheet is located. Thirdly, when scanning the last bar code 412, the print job control system 312 may be instructed that the number associated with this bar code identifies the set page number before which (or after which) the marking sheet is located. With this information, the print job control system 312 initiates reprinting of a portion of the print job. In the example of illustration 402, the print job control system could initiate reprinting of “print job 1” beginning at “set 2,” “page 1”.

Also shown in illustration 402, the marking set 408, 410, 412, 450, 452, 454, 456, 458, 460 include redundant markings having different formats. For example, the subset of markings 450, 452, 454, 456, 458, and 460 includes human-readable markings (text 456, 458, 460 and numbers 450, 452, 454) identifying the same location in the print job as the subset of markings 408, 410, 412, which includes computer-readable bar code markings. An advantage of this arrangement is that different formats allow redundancy in being able to read the marking information in the event that a reading device, such as reading device 324 is not available or is not operational. For example, in the example of illustration 402, a human operator is able to immediately determine the information encoded in the bar codes 450 in the event that the reading device 324 is not connected or is not operational. Therefore, the operator, by looking at the sheet 402, is able to immediately determine that the error occurred immediately before (or after, depending upon implementation choice) job 1, set 2, page 1.

Illustration 404 shows that a marking set can include only a single marking, such as bar code 414, in lieu of all of the plurality of markings 408, 410, 412, 450, 452, 454, 456, 458, 460 shown in illustration 402. While the arrangement of illustration 404 simplifies the process of reading information by the reading device 324, it requires that additional processing be performed by the print job control system 312. Namely, when the reading device reads the marking 414, it provides such number to the print job control system 312. The print job control system 312 then decodes the significance of that number by submitting it to a data storage system. The data storage system includes a database that decodes the number from marking 414 and transmits the job number, set number, and page number associated with the marking 414 back to the print job control system 312 to facilitate reprinting.

Illustration 406 shows that a separate marking page, such as marking sheet 323 need not be provided. In particular, the marking set may be built into pages already existing in the print job. For example, a marking set may include a bar code 416 that may be printed on the last page of each set in a print job in a margin area that will not effect the appearance or value of the ultimately printed print job. An advantage of this arrangement is that extra sheets need not be printed just for the marking sets. However, this arrangement may not be appropriate for print jobs where the marking sets may interfere with the aesthetics of the job.

Although the examples of FIG. 4 show that bar codes may be used as markings, the invention is not so limited. In particular, watermarks or other types of information providing markings may be used in lieu of bar codes. So long as the reading device 324 or an operator is/are capable of reading such marking, it may be used. In this regard, if the marking is only human readable, the reading device 324 is not necessary. In this case, an operator may manually read the information from the marking sets and manually provide it to the print job control system 312, such as through the data input system 304.

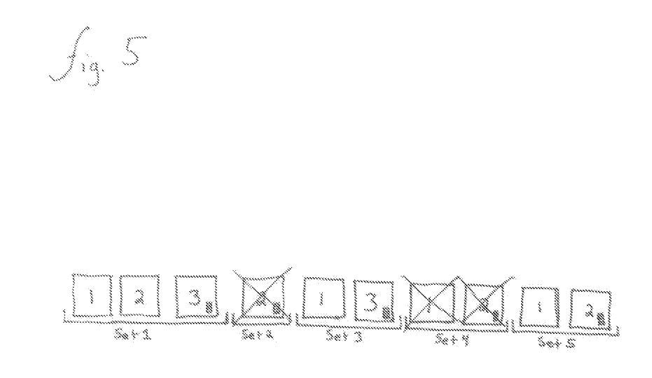

FIG. 5 illustrates treatment of another type of error, according to an embodiment of the present invention. In this example, non-adjacent pages in a printed job fail to be properly printed or finished, whereas pages in between those non-adjacent pages are successfully printed or finished. In the example of FIG. 5, an operator may provide the marking set on the third page of “set 1” and a marking set on the second page of “set 3”. By providing both marking sets to the reading device 324, the control system 312 is able to determine that “set 1” and “set 3” printed properly. Consequently, the control system 312 orders the reprinting of “set 2”. Further, by additionally providing the marking set on page two of “set 5”, the control system 312 knows that “set 5” printed correctly. Accordingly, the print job control system 312 is able to determine that “set 4” also did not print properly and needs to be reprinted.

Although the preceding example of FIG. 5 shows markings at the end of document sets, one skilled in the art will appreciate that marking sets may be provided at any location within a print job. For example, without limitation, marking sets may be provided on every page of a print job, every other page of a print job, every tenth page of a print job, every first page in a document set, every last page in a document set, etc. Further, to the extent that separate marking sheets are used, it may be advantageous to provide fewer marking sets than would be provided in other embodiments. In particular, the more marking sheets that are provided the more pages will be used up for the marking sheets. However, more marking sheets reduces the number of excess pages that need to be reprinted in the event of an error.

Further in this regard, according to an embodiment of the present invention, the format and locations of the marking sets inserted into a print job are user-definable. An advantage of allowing a user to define the format and locations of the marking sets is that it provides the user with the ability to control the aesthetic impact the marking sets may have on the print job. For example, if a user is running a print job that has no space to place a marking set, the user can configure the marking sets to be printed on their own sheets in the print job, separate from any sheets of the print job containing content. In this case, if the user is concerned about the number of extra sheets required to include such marking sets, the user may specify a low frequency of occurrence of these marking sheets. For example, the user may specify that the marking sets occur every five-hundred sheets or, alternatively, every one-hundred document sets. In return for reducing the number of marking sheets used, the user increases the number of pages that would have to be reprinted in the event of a failure.

Other examples of user-defined locations of marking sets include allowing a user to specify where on a sheet the marking sets are to be placed. If a particular print job has extra space in the top margin, the user can specify that the marking sets are to be located there. Another print job, however, may have extra space in the bottom margin. In this case, the user can specify that the marking sets be located in the bottom margins.

In addition, the user can specify the format of the marking sets. For one type of print job, a bar code marking may be sufficient as a marking set. For another, however, a watermark may be more appropriate. Whatever format the user selects, however, should be capable of being read by the reading device 324, if the user desires to use the reading device 324.

It is to be understood that the exemplary embodiments are merely illustrative of the present invention and that may variations of the above-described embodiments can be devised by one skilled in the art without departing from the scope of the invention. For example, although the invention is described in the context of variable data printing, one skilled in the art will appreciate that it applies equally well to the static data printing context. It is therefore intended that all such variations be included within the scope of the following claims and their equivalents.

### PARTS LIST

M marking label
1 set
2 set
3 set
100 printing system
102 print job
104 printer-front-end
106 document
108 document
110 document
112 printer
114 finishing devices
116 in-line finishing components
118 status information
120 off line finishing components
122 job fulfillment
124 arrangement
200 print system
202 print job
204 printer-front-end
206 document
208 document
210 document
212 printer
214 finishing devices
216 in-line finishing components
218 status feedback loop
220 off line finishing components
300 system
302 print job definition
304 data input system
312 print job control system
314 printing components
315 sheets
316 first printing component
316a printing engine
316b in-line finishing component
318 status information
320 second printing components
323 sheet
324 reading device
402 illustration
404 illustration
406 illustration
408 marking
410 marking
412 marking
414 marking
416 barcode
450 bar code
452 human readable text
454 human readable numbers

What is claimed is:

1. A method for facilitating recovery of an interrupted print job printed by a printing system, the printing system having a print job controller and one or more certain components that do not communicate print job status information to the print job controller, the method comprising incorporating a plurality of marking sets into the print job, each marking set having a different location in the print job, and each marking set indicating a location in the print job, such that when the print job is interrupted during printing by one of the one or more certain components, one or more of the marking sets is/are configured to facilitate identifying a portion of the print job that was not printed due to the interruption,
wherein
(1) each of the marking sets is located on its own separate sheet in the print job, the separate sheets not containing print job content, or
(2) locations of the marking sets in the print job are user-configurable, or
(3) each of the marking sets includes marking subsets of different formats, all marking subsets of different formats in a marking set identifying a same location in the print job, or
combinations of (1), (2), and (3).

2. The method of claim 1, wherein the marking sets each comprise a single marking that, when read, communicates a location in the print job.

3. The method of claim 1, wherein the marking sets each comprise a plurality of markings.

4. The method of claim 1, further comprising the steps of:
receiving information from at least one of the marking sets from a reading device that read the at least one of the marking sets, the reading device communicatively connected to the print job controller; and
instructing reprinting of the portion of the print job that was not printed due to the interruption based at least upon the received information.

5. The method of claim 1, wherein the marking sets are configured to identify locations in the print job to the print job controller by having a format readable by a reading device communicatively connected to the print job controller, the reading device configured at least to provide data directly or indirectly to the print job controller.

6. The method of claim 1, wherein the print job comprises multiple document sets, and wherein the method further comprises reading a single marking set in order to initiate reprinting of a plurality of document sets of the print job.

7. The method of claim 1, wherein the one or more certain components are off-line finishing components.

8. The method of claim 1, wherein the marking sets include barcodes, watermarks, or barcodes and watermarks.

9. The method of claim 1, wherein the marking sets include text, numbers, or text and numbers.

10. The method of claim 1, wherein the marking sets identify a print job number, a print job page number, a print job set number, or combinations thereof.

11. The method of claim 1, wherein each of the marking sets includes marking subsets of different formats, all marking subsets of different formats in a marking set identifying a same location in the print job, and wherein a marking subset in a first marking set of the marking sets is in a computer-readable format and another marking subset in the first marking set is in a human-readable format.

12. A method for reprinting a portion of a print job, the method comprising:
receiving information identifying locations of marking sets to be inserted into a print job;
inserting the marking sets into the print job at the locations identified by the received information;
printing the print job having the marking sets inserted therein with one or more first printing components and one or more second printing components, wherein the first printing components provide certain feedback information regarding a status of their printing of the print job, and wherein the second printing components do not provide the certain feedback information regarding a status of their printing of the print job;
reading a marking set from the marking sets inserted into the print job;
determining a portion of the print job to be reprinted based at least upon the reading of the marking set; and
reprinting at least the portion of the print job.

13. The method of claim 12, wherein each of the marking sets is located on its own separate sheet in the print job, the separate sheets not containing print job content.

14. The method of claim 12, wherein each of the marking sets includes marking subsets of different formats, all marking subsets of different formats in a marking set identifying a same location in the print job.

15. The method of claim 14, wherein a marking subset in a first marking set of the marking sets is in a computer-readable format and another marking subset in the first marking set is in a human-readable format.

16. The method of claim 12, wherein the marking sets each comprise a single marking that, when read, communicates a location in the print job.

17. The method of claim 12, wherein the marking sets each comprise a plurality of markings.

18. The method of claim 12, wherein the print job comprises multiple document sets, and wherein the portion of the print job comprises a plurality of the document sets.

19. The method of claim 12, wherein the one or more first printing components are in-line finishing components and the one or more second printing components are off-line finishing components.

20. The method of claim 12, wherein the marking sets include barcodes, watermarks, or barcodes and watermarks.

21. The method of claim 12, wherein the marking sets include text, numbers, or text and numbers.

22. A printing system comprising:
a data input system configured at least to receive information identifying locations of marking sets to be inserted into a print job;
a print job control system communicatively connected to the data input system, the print job control system configured at least to (a) receive the information from the data input system, (b) insert the marking sets into the print job at the locations identified by the received information, each marking set identifying a location in the print job, and (c) manage printing of the print job;
one or more first printing components communicatively connected to the print job control system, the first printing component(s) configured at least to (a) print at least a portion or aspect of the print job having the marking sets inserted therein, and (b) provide certain feedback information to the print job control system regarding a status of the printing of the print job by the first printing component(s);
one or more second printing components configured at least to print at least a portion or aspect of the print job having the marking sets inserted therein, wherein the second component(s) is/are not configured to provide the certain feedback information to the print job control system regarding a status of the printing of the print job by the second printing component(s);
a reading device communicatively connected to the print job control system and configured at least to (a) read a marking set from the marking sets inserted into the print job, and (b) transmit data pertaining to the reading of the marking set to the print job control system,
wherein the print job control system further is configured at least to (a) receive the data from the reading device, and (b) instruct the reprinting of a portion of the print job based at least upon the data received from the reading device, the data received from the reading device being used to determine which portion of the print job is to be reprinted.

23. The system of claim 22, wherein each of the marking sets is located on its own separate sheet in the print job, the separate sheets not containing print job content.

24. The system of claim 22, wherein each of the marking sets includes marking subsets of different formats, all marking subsets of different formats in a marking set identifying a same location in the print job.

25. The system of claim 24, wherein a marking subset in a first marking set of the marking sets is in a computer-readable format and another marking subset in the first marking set is in a human-readable format.

26. The system of claim 22, wherein the marking sets each comprise a single marking that, when read, communicates a location in the print job.

27. The system of claim 22, wherein the marking sets each comprise a plurality of markings.

28. The system of claim 22, wherein the print job comprises multiple document sets, and wherein the portion of the print job comprises a plurality of the document sets.

29. The system of claim 22, wherein the one or more first printing components are in-line finishing components and the one or more second printing components are off-line finishing components.

30. The system of claim 22, wherein the marking sets include barcodes, watermarks, or barcodes and watermarks.

31. The system of claim 22, wherein the marking sets include text, numbers, or text and numbers.
